(19) United States
(12) Patent Application Publication
(10) Pub. No.: US 2003/0010234 A1
(43) Pub. Date: Jan. 16, 2003

(54) PROCESS AND APPARATUS FOR GRAVURE

(76) Inventors: ARMIN WEICHMANN, KISSING (DE); ARMIN FRANZ-BURGHOLZ, BERLIN (DE); RAINER STAMME, AUGSBURG (DE); ANDREAS SCHILLER, MERING (DE); HANS FLEISCHMANN, AUGSBURG (DE)

Correspondence Address: THOMAS C PONTANI ESQ, COHEN PONTANI LIEBERMAN & PAVANE, 551 FIFTH AVENUE, SUITE 1210, NEW YORK, NY, 10176

(21) Appl. No.: 08/999,954

(22) Filed: Dec. 5, 1997

(30) Foreign Application Priority Data
Feb. 7, 1995 (DE) 195 03 951.3

(51) Int. Cl. B41F 9/00

(52) U.S. Cl. 101/154

(57) ABSTRACT

A process for gravure by means of an erasable and reusable gravure form proceeds from a gravure blank form with a base screen which is designed at least for the maximum amount of ink to be transferred. The depressions of the base screen of the gravure blank form are uniformly filled with a liquefiable substance by means of an applicator device and material is then removed from the depressions in conformity to the intended image by means of thermal energy applied by an image-point transfer device. The printing form is then inked by means of an inking system and, finally, is regenerated after the printing process to produce a gravure blank form, wherein the depressions of the base screen are filled again in a uniform manner.

The invention is directed to a process and an apparatus for gravure by means of an erasable and reusable gravure form proceeding from a gravure blank form with a base screen which is designed at least for the maximum amount of ink to be transferred.

Gravure refers to a printing process using printing elements which are depressed relative to the surface of the form. After the printing form is completely inked, the printing ink is removed from the surface. The ink remains only in the depressed areas. Copper-coated steel cylinders, hollow cylinders mounted on tensioning cores or, in many cases, copper plates clamped on cylinders may be used as printing forms, for example.

Due to the type of inking and the wiping of the surface of the form with doctor blades, pure surface printing is not possible. The entire graphic must be resolved into lines, dots or screen elements. Due to their differing depth and magnitude, the individual printing elements take up varying amounts of printing ink. Consequently, the impression will have different ink values at different locations on the image.

Various working methods are currently used for producing a gravure form. For instance, in the variable-depth method, the etching principle consists in a gradual diffusion of concentrated ferric chloride solutions through a pigment-gelatin layer. The pigment reproduction on the copper printing form is formed of a hardened gelatin relief corresponding to the gradation of tones of the transparencies. The engraving process is characterized by line-scanning of the image and text by photocells and simultaneous engraving of the printing form by engraving heads. It should be noted in particular that depressions are made in the copper layer of the printing form by means of a high-energy electron beam which is directed on the blank form under vacuum and removes material in conformity to the intended image. The printing form which is engraved in this way can be provided with screens with varying depths and surfaces.

Depressions can also be made by means of a high-energy laser beam. In so doing, appropriate steps must be taken to ensure that the laser energy is coupled into the substrate, since copper is especially prone to reflect a laser beam when not subjected to special preconditioning.

Further, DE-OS 27 48 062 discloses a process for producing an engraved printing form in which a gravure blank form is first prepared by providing the smooth surface with depressions of equal depth and magnitude in a uniform manner and then covering the engraved surface with a light-sensitive substance so as to fill up all of the depressions. The blank form is then exposed photographically with the desired image so that the exposed areas are polymerized and the unexposed portions can be washed off, resulting in a differentiated image.

It can be asserted in general for all gravure processes that the depth of image locations on the printing form is greater than that of nonimage locations. In doctor-blade gravure, in particular, the screen grid forms webs of uniform height which define the image locations and form a support surface for the doctor blade. A special set of printing form cylinders (for each printing ink there must be one printing form cylinder with a corresponding number of printing sides) is required for every printing job. These cylinders are produced with the required cylinder circumference depending on the printing format. When setting up the gravure press or rotary printing machine, the appropriate printing form cylinders must be exchanged. A modern cylinder of this type, e.g., with a width of 200 cm, weighs approximately 800 kg. The mechanical cost for the processes described above is very high, since these processes can only be carried out outside the printing machine. In addition, each of these production processes involves steps such as electroplating or coating, exposure and development, which rules out the possibility of reusing the same printing form without extensive processing, in particular chemical processing. Further, after etching or engraving to form the image, that is, after removal of material, chroming is usually carried out to prolong service life.

If the printing form is to be stored for subsequent repeated applications, it is generally necessary to reserve space for the entire cylinder. For this reason, production of printing forms is very involved and therefore expensive, particularly when electroplating is required. Moreover, the resulting toxic sludge is objectionable in ecological respects.

On the other hand, DE 38 37 941 C2 discloses a process for producing a gravure form in which the image can be produced directly in the printing machine and in which, moreover, the image can be removed from the gravure form in the printing machine and the gravure form can be prepared for a new image. Likewise in this case, a gravure blank form is produced with a base screen designed at least for the maximum amount of ink to be transferred. In the printing machine, an amount of thermoplastic substance in inverse proportion to the image information is then introduced into the depressed portions from a nozzle of the image-point transfer unit or by means of image-correlated ironing so as to reduce the effective volume of the depressions. In other words, in contrast to the other methods, the image is formed on the gravure blank form by image-forming application of material. After the printing job, the thermoplastic substance can then be liquified in the printing machine by means of a heat source and removed from the printing form cylinder by a wiping and/or blowing or suction device.

However, the application of material to form images raises problems with respect to the positioning accuracy of the image. Material deposited on the webs cannot easily be introduced into the depressions completely. Yet, in order for all of the transferred material to contribute in a desired manner to the reduction in the effective volume of the depressions, this material must be introduced in its entirety.

Accordingly, the object of the present invention is to develop a process and an apparatus for gravure printing in which the gravure printing form can be produced inexpensively and also directly in the printing machine and in which the positioning of the image can be made more accurate.

This object is met by the process steps contained in claim 1 and by the apparatus for carrying out the process according to claim 22.

Storage of gravure forms is eliminated since the cycle of characterizing process steps can be carried out repeatedly.

Another special advantage of the process according to invention and of the apparatus for carrying out this process consists in that wear on the gravure blank form is compensated for because the maximum image-forming depth in the applied substance on the gravure printing form is appreciably less than the original depth of the depressions of the prestructured blank form. That is, if the depth of the depressions is reduced due to wear on the webs, the maximum image-forming depth can nevertheless be achieved by a wide margin. For this reason, the webs of the blank form are also advantageously constructed so as to extend vertically to the surface of the gravure form as far as possible.

Advantageous constructions are contained in the dependent claims.

Preferred embodiment examples and variants of the invention are explained in the following with reference to the highly schematic drawings.

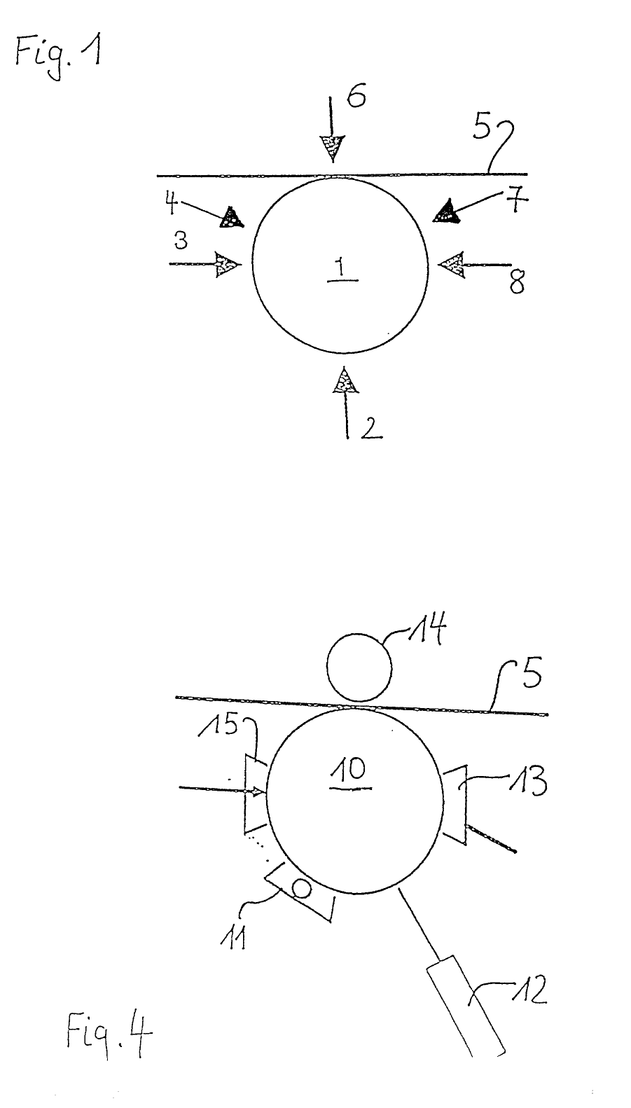

FIG. 1 shows the basic construction for carrying out the process steps according to the invention;

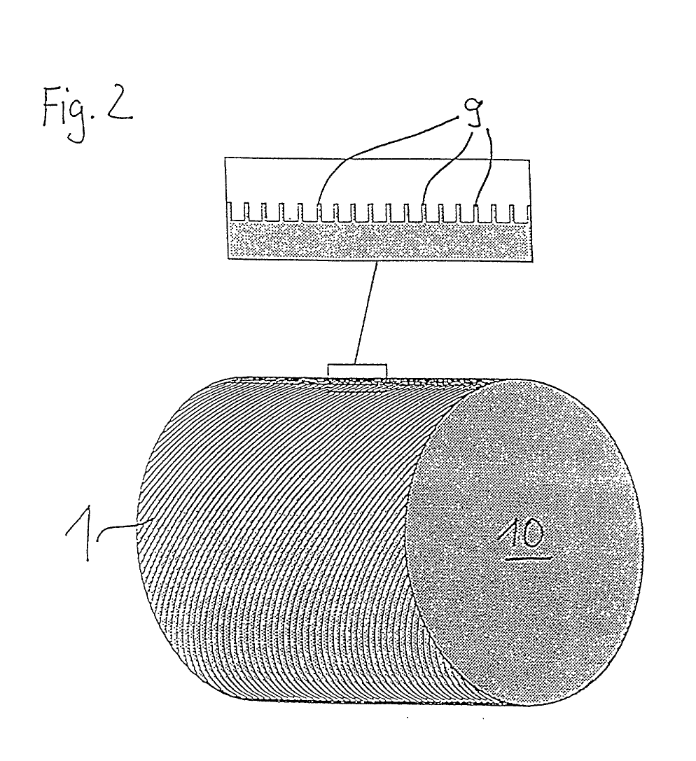

FIG. 2 shows a detailed view of the surface of a gravure blank form;

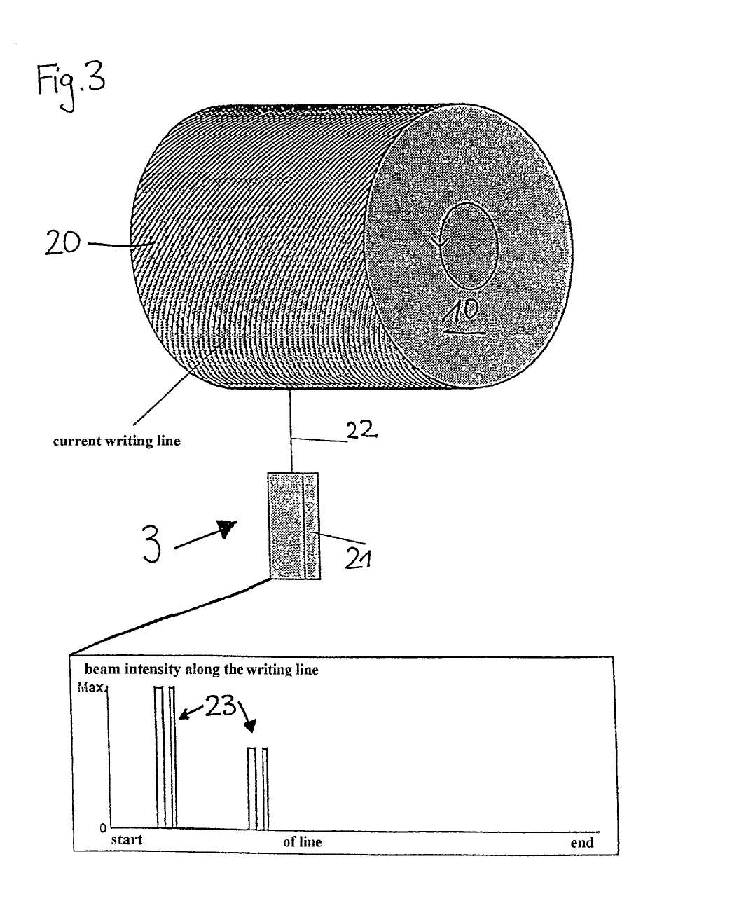

FIG. 3 shows the ablation of the liquefiable substance from the surface of a gravure form for the purpose of forming images depending on a given laser beam intensity per writing line;

FIG. 4 shows an embodiment example of an apparatus according to the invention;

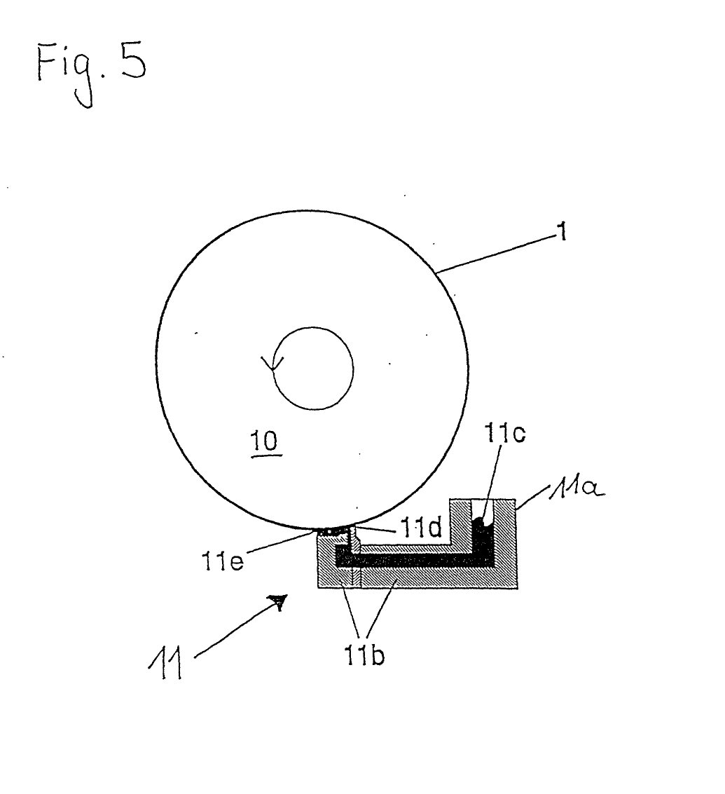

FIG. 5 shows an applicator device;

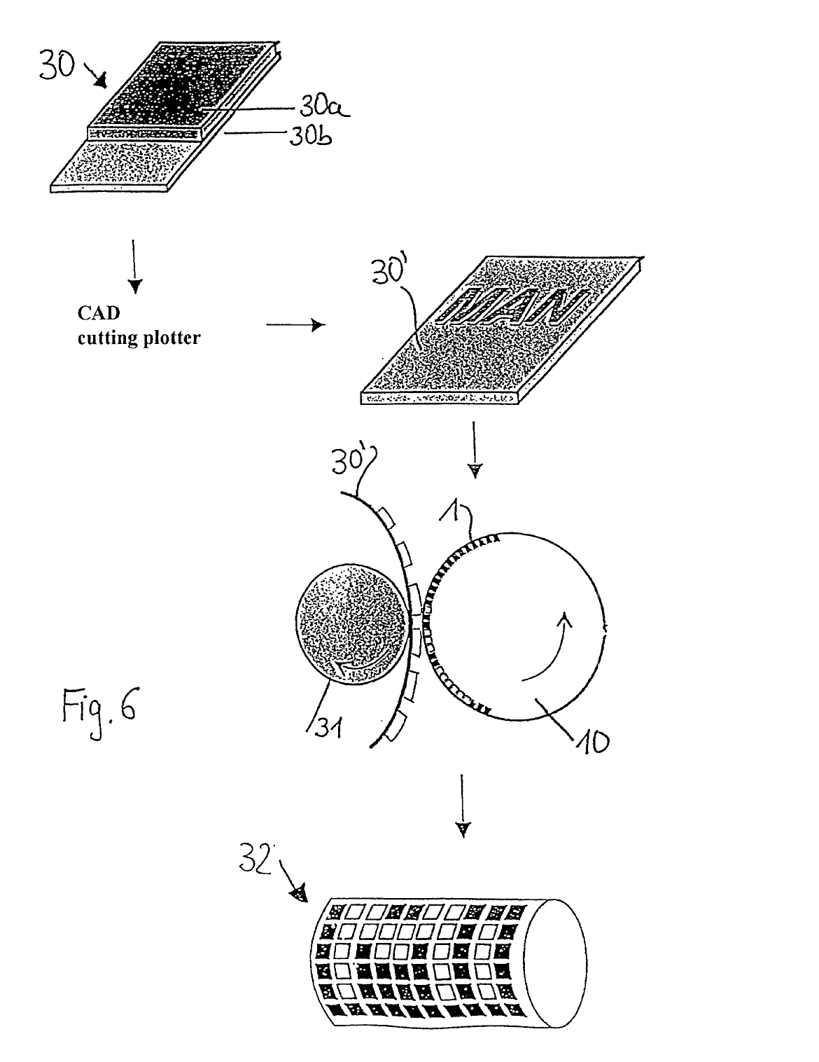

FIG. 6 shows an image-point transfer device for image-forming ablation by suction;

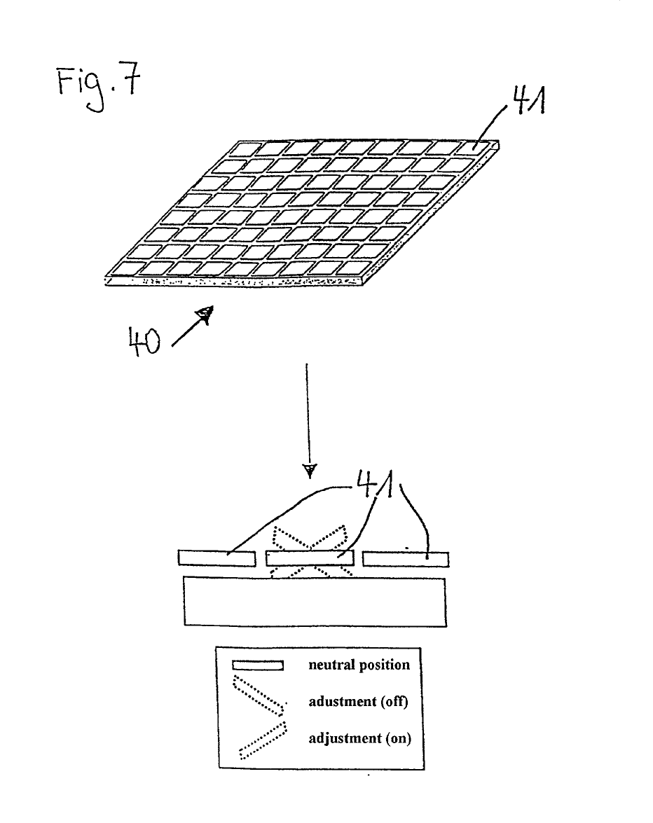

FIG. 7 shows the construction of a micromirror array for an image-point transfer device for image-forming ablation;

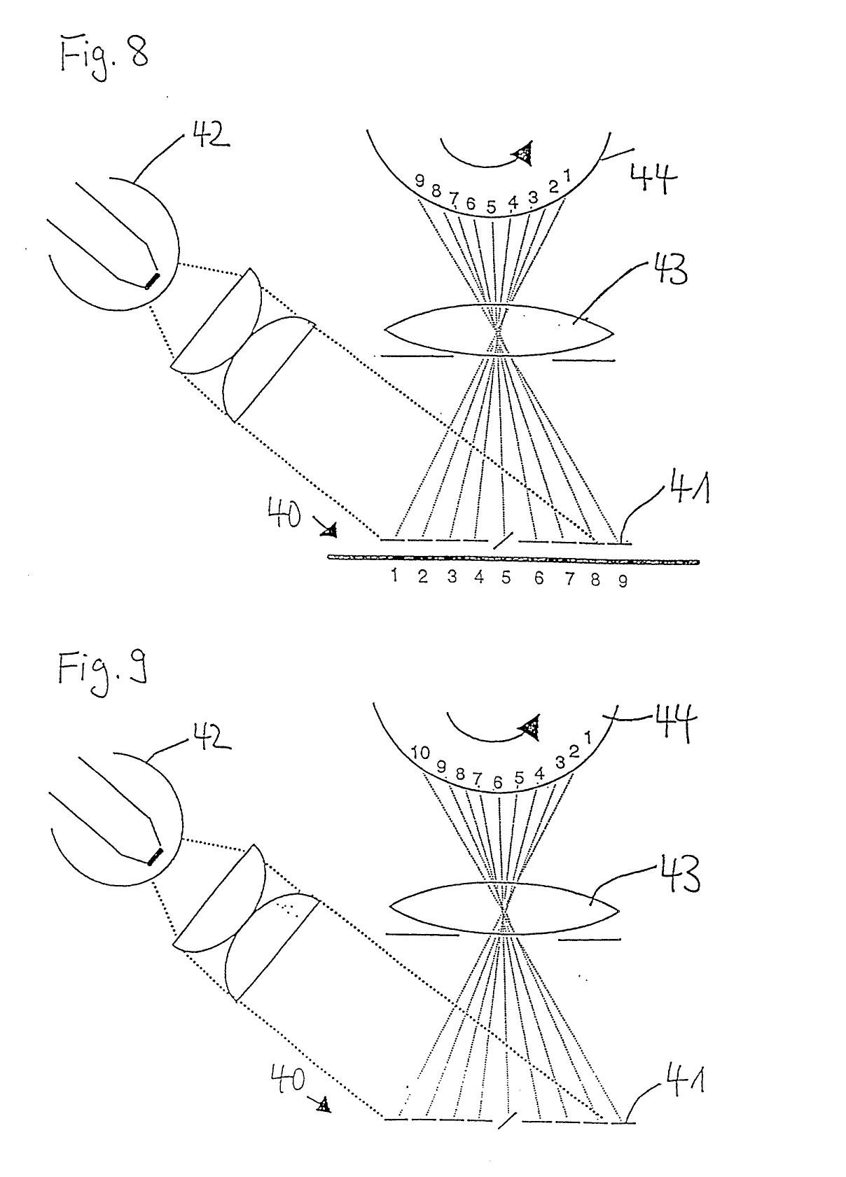

FIGS. 8 and 9 show an arrangement for image-forming ablation according to FIG. 7.

The image can be formed on the blank form 1 directly in the printing machine with the process and apparatus according to the invention. The gravure form on which an image has been formed can also be erased and prepared for reuse in a simple manner in the printing machine.

As is shown in FIG. 1, a prestructured gravure blank form 1 with a base screen designed for at least the maximum amount of ink to be transferred is filled 2 in a first step with a liquefiable substance by means of an applicator device. The substance used for filling may be, e.g., a thermoplastic or wax (hot melt), lacquer or crosslinkable polymer melt or polymer solution which is also known as a reactive system and which is characterized by an extremely high resistance to abrasion. The surface of the gravure form is then substantially smooth. The filled in substance is then removed from the depressions so as to form an image by means of thermal energy applied by an image-point transfer device. The gravure form can now be inked 4 by means of an inking system so that printing stock 5 may be printed upon 6 by gravure.

After the printing process 6, the surface of the gravure form is regenerated in that the ink residues are cleaned off 7, the liquefiable substance is preferably completely removed 8 from the prestructured depressions, and the depressions are filled again in a uniform manner. The liquified substance can be removed from the prestructured depressions by means of a heat source and/or by a blowing or suction device.

FIG. 2 shows a prestructured gravure blank form 1 on a cylinder 10 with webs 9 which extend helically around its cylindrical surface at a defined angle. The spacing between the webs 9 preferably corresponds to the spacing of currently used gravure screens. For an 80 line/cm screen, this spacing would be 125 μm. However, the spacing may also be substantially greater provided that the webs 9 can still guide the doctor blade dependably without noticeable flexing of the doctor blade and without resulting in excessive wear on the webs 9. The gravure blank form 1 is generally resistant to wear at least at the web surfaces, e.g., it is coated with chrome or titanium oxide or is produced from ceramics and is thus inherently very hard, and/or is provided with a defined roughness so that the doctor blade glides on a defined liquid film during printing.

After the depressions between the webs 9 of the gravure blank form 1 have been filled with the liquified thermoplastic substance, the gravure form 20 can be provided with an image by burning off, as shown in FIG. 3, by the thermal energy of an image-point transfer device, in particular a laser 21 in a manner analogous to an external drum exposer. Nd YAG or NDYLF lasers which are switched in a plurality of intensity levels 23 via an acousto-optical modulator are preferably used. The laser beam 22 can be guided to the gravure blank form 1 and focussed thereon via an optical fiber. It is preferable not to exceed a cell size of more than approximately 2/10 mm. That is, approximately after reaching this distance at most, the image-forming ablation produces a web which does not serve to guide the inking doctor, but rather to compel the cell to be emptied of ink during printing. Thus, it is possible in particular to address surfaces (pixels) which are smaller than an actual gravure cell so that a cell may be produced by a plurality of pixels.

Further, the image-forming ablation 3 can be assisted by setting the filled gravure blank form 1 in rapid rotation in such a way that some of the material to be removed is evaporated and some is thrown off.

In an advantageous variant, the gravure blank form 1 is not constructed as a solid cylinder, so that a low heating capacity is achieved. Thus, a thermally insulating layer, e.g., of fiberglass-reinforced carbon, is provided between a base layer and the surface layer which carries the base screen of the gravure blank form 1 and has a thickness of several tenths of a millimeter. The thermoplastic used as liquefiable substance can also be a resin or a synthetic or natural wax.

FIG. 4 shows a preferred embodiment example of an apparatus for implementing the process according to the invention.

A device 11 for applying a liquefiable substance directly to a gravure form cylinder 10 supporting the gravure blank form 1 is arranged inside the gravure press so as to be adjustable. A preferred construction of this device 11 is illustrated in FIG. 5. This device 11 comprises a box 11a which opens toward the surface of the gravure blank form 1 and contains a heating cartridge 11b. The device 11 is heated and contains the molten thermoplastic 11c which can be filled and refilled in granulated form. The melt 11c is introduced on the surface of the gravure blank form 1 by gravitational force and capillary action and penetrates into the depressions of the base screen. Compressed air or hydraulic pressure generated by means of a pump can also be used instead of gravitational force. Due to the narrow gap between the gravure blank form 1 and the applicator device 11, a capillary and hydrodynamic force introduces precisely the amount of substance required for filling.

In a variant construction of this embodiment example, two formed strips 11d, 11e (FIG. 5) are provided for the device 11. One of them (11e) is provided in front of the narrow gap between the gravure form 1 and applicator device 11 while the other (11d) is arranged after this gap as viewed in the rotating direction of the gravure form cylinder 10. The formed strip 11d subsequent to the gap is held in a positive engagement against the cylinder 10 at a very small distance thereto (some hundredths of a millimeter) by means of precise guidance or by supporting cheeks and is designed so as to be heatable in order to adjust the viscosity of the filling material so as to promote the effect of the hydrodynamic forces and ensure a complete filling of the depressions of the base screen. Further, the rear edge of this strip 11d is sharpened in order to ensure a clean tearing of the filling material from the gap. The front formed strip 11e is held against the cylinder 10 at a greater distance (several hundredths of a millimeter to several tenths of a millimeter) so that the gap, which accordingly widens, is filled with material but the hydrodynamic forces have an appreciably reduced effect. The actual filling occurring in the region of the formed strip 11d is accordingly prepared, in particular by means of heating and pre-filling the thermally insulated surface of the printing blank form.

An excess amount of the liquefiable substance 11c can also be applied to the gravure blank form 1 in the heated state. After cooling, the surplus is then removed, i.e., wiped and/or polished, from the gravure blank form 1 by means of an adjustable doctor blade 12. The doctor blade 12 can change for this purpose. After the thermoplastic has cooled, the filled surface of the gravure blank form 1 is preferably polished again in order to adjust the roughness of the surface in a defined manner.

After ablation 3 of the filled gravure blank form 1 in accordance with the intended image, the gravure form can be inked by means of an inking system 13. A chamber doctor is preferably used for this purpose since it requires less space at the circumference of the cylinder than a conventional inking system and can simply be withdrawn from the gravure cylinder 10 during the other process steps. Of course, the applicator devices 11, doctor blade 12 and image-point transfer unit (e.g., the laser 21) and other devices can be removed from the gravure cylinder 10 during the inking so as to protect them from ink and ink mist.

As will be seen from FIG. 4, printing stock 5 can now be printed against an impression cylinder 14 by gravure, but preferably by indirect gravure. In indirect gravure, the paper is not printed upon directly by the printing form cylinder, but rather a roller coated with a smooth rubber surface is located between the printing form cylinder and the paper. This roller serves as an intermediate substrate and thus decouples the printing form cylinder from the printing stock. In conventional direct gravure, two hard materials roll off one another in the printing gap between the printing form cylinder and printing stock, one of which, the printing stock, has an abrasive action in addition. In order to counter this, hard materials are required for the printing form. In indirect gravure, two printing gaps are used instead of one, wherein a hard material rolls off a soft material in each case. In addition, the printing form cylinder no longer comes into direct contact with the abrasive paper medium. This permits substantially softer materials to be used without decreasing the service life of the materials. The doctor blade, the other part which is subject to wear at the printing form cylinder, is guided by the webs formed of hard material and thus also does not contact the softer filling material suitable for thermal ablation. As a result of this step, the service life of a gravure form produced according to the invention is substantially improved.

After the required printing process, ink residues are cleaned off the gravure form by means of a regenerating device 15, preferably in the form of an ultrasonic cleaning installation which is likewise constructed as an adjustable system similar to a chamber doctor, and the liquefiable substance is removed from the depressions of the base screen of the printing blank form 1 so that the cycle (filling 2, image-forming ablation 3, inking 4, printing 6, regeneration 7, 8) can start from the beginning.

The ultrasonic cleaning installation can be operated on at least two different levels. One level with low sonic energy and/or with a liquid which only loosens the ink serves to remove the remaining ink. The other levels with correspondingly higher sonic pressures and/or other cleaning agents serve for partial or complete removal of the filling material.

Another important advantage of the invention consists in the noticeable improvement in quality compared to conventional gravure, particularly with respect to text reproduction. This is achieved in that the writing resolution for producing images lies well below the spacing between two webs, e.g., 500 lines per cm. Accordingly, text can be screened at this high resolution and character edges can be achieved which are substantially sharper than in conventional gravure. In general, approximately 400 lines per cm are specified as the lower limit for good text reproduction. Conventional gravure form production has a resolution of 120 lines per cm maximum and must therefore simulate sharp edges with more or less small dots interrupted by blank spaces. This is why gravure text always has a sawtooth effect, as it is called.

In order to achieve the same quantity of gray steps in the image as the gravure which varies every dot in up to 200 depth steps, a binary exposer, i.e., one working in variable-surface operation, must be able to write at least 1000 lines per cm. Although this binary writing mode is also suitable in principle, the present invention preferably uses a combination of variable-surface and conventional, i.e., variable-depth, gravure screening known as a hybrid screen. This screen is written, for example, with 500 lines per cm. However, every dot can be graduated in a plurality of depths. For instance, five different depths (0%, 25%, 50%, 75% and 100%) at a writing resolution of 500 lines per cm achieves the same halftone quality as a writing resolution of 1000 lines per cm and only two depths (0% and 100%) or a writing resolution of 100 lines per cm and 101 different depths. If 10 different depths are used, for example, this corresponds to the information content of 250 gray steps at 100 lines per cm. The present density information which is typically given at a resolution of 256 steps is converted into the hybrid screening model, which has appreciably fewer than 256 steps per writing point, typically roughly 10, by the known preliminary printing step techniques of “error diffusion”, dithering or stochastic screening. All of these methods are normally used only for binary screening, but can be expanded to more than two thresholds. In particular, an image pixel can be ablated in a number of steps of different depth ranging from 2 to 256.

In order to reduce the necessary maximum depth of the depressions, between 20 μm and 40 μm in conventional gravure, highly pigmented, particularly water-based, inks are used. The advantages of this reduction reside in the lower image-forming output required for achieving a given ink density and in the reduced addition of water in the paper, which considerably accelerates drying.

Wear on the gravure blank form is compensated for in that the maximum image-forming depth is appreciably less than the depth of the depressions in the prestructured gravure blank form. If the depth of the depressions is reduced as a result of wear of the webs, the maximum image-forming depth can nevertheless be easily attained. For this purpose, the webs are to be structured with vertical walls as far as possible. Narrowing of the depressions as a result of increasing web thickness can be compensated for during exposure by process techniques by determining the volume characteristic at periodic intervals and compensating accordingly.

Different advantageous variants of the steps according to the invention are possible. For example, a blank form with uniformly arranged depressions, as used in conventional form production, can be used instead of the gravure blank form with helically arranged webs as described above. The magnitude of the depressions can differ from the fine screens commonly used today which have cell sizes starting from 80 μm to very large depressions with respect to area, e.g., cell sizes of 1 mm or more. The form can have stochastically distributed depressions instead of uniformly distributed depressions in order to prevent the risk of moire formation, particularly when printing with multiple inks. The random distribution can be produced, e.g., by exposing the gelatins used for conventional etching with speckles produced from coherent laser light rather than with a cross-line screen. In this case, a wax combined with 5% carbon black is preferably used as filling material.

The regeneration of the gravure form can also be carried out with high-pressure water jets. For example, an arrangement such as that already disclosed by EP 9 310 798 is used for this purpose. An arrangement of this kind is formed of a double-walled chamber which is open toward the gravure form and is closed off relative to the surroundings by seals guided along the form. The inner cell contains nozzles through which water is sprayed at high pressure on the surface of the gravure form. Suction is applied to the covered outer chamber region so that the liquid is removed in particular from the region which has already been cleaned and the gravure form is clean and dry after processing.

The high-pressure cleaning arrangement can operate on at least two different levels. One level with low liquid pressure and/or liquid temperature serves substantially to remove remaining ink, while the additional levels with correspondingly higher liquid pressure and/or liquid temperature serve for partial or complete removal of the filling material.

Different pressure and temperature parameters are applied depending on whether a first cleaning or intermediate cleaning is to be carried out. If only adhering dirt and ink residues are to be cleaned off, a relatively low temperature in the range below 50° C. and low pressure of several bar will be used. If a first cleaning is to be carried out, temperatures in the range of the softening or melting temperature and pressures in the range of 30 bar are to be used. Agents such as surfactants as well as particles can be added to the cleaning water to improve effectiveness.

The depressions in the gravure blank form can also be filled by an applicator roller which draws from a material reservoir and preferably rotates in the opposite direction to the rotating direction of the gravure form cylinder. After application, the filling material is wiped off by a doctor blade. The angle of the doctor blade is preferably distinctly negative, i.e., the doctor blade cuts like a knife. In particular, the doctor blade can also be heated. The gravure form can also be heated inductively before and during filling and during wiping. Regeneration, filling and wiping can preferably be effected during one and the same cylinder revolution.

If thermoplastics are used, heat may be applied, for instance, via an infrared radiation source or heated air and materials which suck the thermoplastic out of the depressions by capillary action or, e.g., a highly absorbent paper or a blowing or suction device can be used.

It is also possible to clean only adhering dirt and ink from the gravure form without removing filling material and to refill the portions of the form removed during the preceding image formation step. Complete erasure can then be carried out after a given number of cycles to produce a blank form.

Further, photopolymers which are hardened by laser and developed by means of water can also be used as filling materials. Lacquer can also be applied successively in multiple layers with intermediate drying in order to fill the depressions completely, or the reactive systems already mentioned above can also be used. The filling materials are sensitized to the type of radiation used, e.g., by adding carbon black.

The surface of the gravure form can be smoothed after filling by polishing or wiping with a heated doctor blade. This can also be effected by means of a hot-air jet or by the laser beam used for image-forming ablation at low beam intensity. This can be carried out in the course of normal image formation by irradiating the nonimage areas with a defined but considerably lower output in relation to the image-forming ablation so as to result only in melting.

Of course, instead of a laser beam, in particular a high-energy laser beam, a plurality of parallel beams can also be used. Any thermal laser source such as semiconductor lasers, in particular a laser arrangement formed by a plurality of semiconductor lasers, Nd YAG lasers, CO₂ lasers or CO lasers, can be used as radiation wave. A laser radiating in the ultraviolet or blue range, e.g., an argon laser, must be used for photopolymer filling. Further, spark erosion or a water jet can be used instead of a light source for material removal, e.g., if high resolution is not required.

An absorbent paper (e.g., blotting paper) which is cut according to the intended image can also be used. This procedure is explained more fully with reference to FIG. 6. A multilayer foil 30′ is used as a base. An absorbent material 30a (e.g., blotting paper) is applied to a nonabsorbent substrate 30b. The unneeded areas are cut out and removed by means of a CAD cutting plotter as is conventional in foil cutting techniques. The foil 30′ is then applied to the gravure form cylinder 10 which has already been provided with the filled blank form. The foil 30′ is ironed over the gravure form cylinder by means of a heated roller 31. The filling material is then sucked out by means of capillary forces at those locations contacted by the absorbent foil material, whereas this does not occur at the locations in contact with the nonabsorbent substrate. The image can be differentiated 32 in this way. However, it is only possible to differentiate substantially between full tones and paper white.

Image-forming ablation can also be effected by means of a micromirror array 40. The construction of such an array 40 is shown in FIG. 7. A typical array 40 of this kind is formed of individually electrically tiltable micromirrors 41 with a typical area of 20 μm×20 μm arranged in a matrix of 1000×2000 elements.

FIGS. 8 and 9 show an example of an arrangement of an array 40 of this type for an image-point transfer unit for image-forming ablation. The mirror relay 40 is uniformly illuminated by means of a high-energy arc lamp 42 and is imaged on the surface 44 of the printing form by an optical system 43 at an imaging scale of approximately 1 in such a way that the edge of the array 40 with the 2000 elements is disposed vertically to the rotating direction of the form cylinder. This edge defines the image lines. One pixel is defined as the field on which a mirror is imaged geometrically and calculations are carried out relative to the surface of a mirror to determine the half of the nonimaging edge regions adjacent to the mirror until the next respective adjoining mirror. A mirror reflects the energy radiated upon it onto the form and in this pixel when it is so disposed that it reflects at the spatial angle determined by the apertures of the imaging optical system. The printing form cylinder rotates and 2000 image columns are written simultaneously. A mirror addresses a pixel when more than 50% of its surface is imaged thereon. Accordingly, a line of pixels which is stationary with respect to the cylinder travels through the lines of the mirror array 40, i.e., an increasing number of lines of the mirror array are gradually illuminated (FIG. 9).

Suitable electronics (essentially a multielement shift register) provide for an allocation of image data synchronized to this traveling. The image data are filled into the first line. The image data travel downward line by line synchronously with the rotation of the cylinder, and the next respective line of image data is taken over in the first line. During this traveling, a mirror can always be switched on or off. A determined pixel can thus obtain 0 to 1000 units of energy. For instance, in order to act upon a pixel with 4/10 of the maximum energy dose, 400 mirrors are switched on and 600 mirrors are switched off during this wandering, while they address the pixel. Thus, the addressing of the mirror elements 41 is changed synchronously with the rotation of the gravure form surface 44 in a manner analogous to a shift register so that the allocation of an image pixel to the printing form surface 44 with its corresponding exposure data value is maintained on the form surface 44 along the entire imaging surface of the mirror array 40. The arrangement of the on/off mirror is optional, but may possibly be predetermined in conformity to process techniques.

In principle, surfaces (image pixels) which are smaller than the surface elements of the base screen of the gravure blank form 1 can be addressed by the image-forming ablation 3. In particular, the image-forming ablation 3 can even be carried out substantially independently from the base screen. However, the image-forming ablation 3 can also be adapted to the base screen, i.e., can have a determined geometric ratio thereto. Ideally, the image-forming ablation structures the depressions of the base screen as needed according to process techniques.

After one revolution of the cylinder, the print head is displaced by 1000 pixels and the cycle starts from the beginning. Alternatively, a continuous forward feed of the print head which displaces the head by 1000 pixels in one revolution of the printing form cylinder can also be carried out.

All of the constructions mentioned above relate to the implementation of the steps according to the invention in a gravure press. However, the described steps can, of course, also be carried out outside a printing machine.

1. Process for gravure by means of an erasable and reusable gravure form proceeding from a gravure blank form with a base screen which is designed at least for the maximum amount of ink to be transferred, characterized in that the depressions of the base screen of the gravure blank form (1) are uniformly filled (2) with a liquefiable substance by means of an applicator device (11), material is then removed (3) from the depressions in conformity to the intended image by means of an image-point transfer device (21), the gravure form (20) which is screened in conformity to the intended image is inked (4) by means of an inking system (13) and is then printed (9) in gravure, and, finally, the gravure blank form (1) is regenerated (7, 8) after the printing process and the depressions are filled again (2) in a uniform manner.

2. Process according to claim 1, characterized in that the liquefiable substance is introduced into the depressions of the base screen of the gravure blank form (1) in the liquid state by means of hydrodynamic forces, in particular by capillary action.

3. Process according to claim 1 or 2, characterized in that an excess of liquefiable substance is applied in the liquid state to the gravure blank form (1) and, after hardening, the surplus is removed from the gravure blank form (1) by means of a doctor blade (12).

4. Process according to claim 1 or 2, characterized in that the liquefiable substance is applied in the liquid state to the gravure blank form (1) in conformity to the depth of the base screen in that the surplus is removed from the gravure blank form (1) by means of a doctor blade (12) before hardening.

5. Process according to claim 4, characterized in that the base screen of the gravure blank form (1) is filled completely by means of successive multiple applications with intermediate drying.

6. Process according to one of the preceding claims, characterized in that the image-forming ablation (3) is effected by applying thermal energy.

7. Process according to one of the preceding claims, characterized in that the image-forming ablation (3) is assisted in that the filled gravure blank form is set in rapid rotation in such a way that some of the material to be removed is evaporated and some is thrown off.

8. Process according to one of the preceding claims, characterized in that the surface of the gravure blank form (1) is polished after filling.

9. Process according to one of the preceding claims, characterized in that a chamber doctor (13) is used to ink the gravure form (20).

10. Process according to one of the preceding claims, characterized by printing in indirect gravure.

11. Process according to one of the preceding claims, characterized by the use of highly pigmented, in particular water-based, inks for inking the gravure form (20).

12. Process according to one of the preceding claims, characterized in that the regeneration (7, 8) of the gravure blank form (1), which begins with the cleaning (7) of the ink residues from the gravure form (20), comprises complete removal of the liquefiable substance from the depressions of the base screen for every cycle (filling (2), image-forming ablation (3), inking (4), printing (6), regeneration (7, 8)).

13. Process according to one of the preceding claims, characterized in that the regeneration (7, 8) of the gravure blank form (1) provides for complete removal of the liquefiable substance from the depressions of the base screen in a given number of cycles (filling (2), image-forming ablation (3), inking (4), printing (6), regeneration (7)) and only the liquefiable substance which was removed by the image-forming ablation (3) is filled in again in the intermediate cycles.

14. Process according to one of the preceding claims, characterized in that a thermoplastic is used as liquefiable substance.

15. Process according to one of the preceding claims, characterized in that photopolymers are used as liquefiable substance.

16. Process according to one of the preceding claims, characterized in that lacquer is used as liquefiable substance.

17. Process according to one of the preceding claims, characterized in that a crosslinkable polymer melt or polymer solution (reactive systems) is used as liquefiable substance.

18. Process according to one of the preceding claims, characterized in that a foil (30′) which is cut in conformity to the intended image is used for the image-forming ablation (3), this foil (30′) being ironed over the filled gravure blank form (1), and the absorbent foil material (30a) arranged in conformity to the image sucks the filling material out of the depressions of the base screen of the blank form (1).

19. Process according to one of the preceding claims, characterized in that the image-forming ablation (3) is effected by means of a micromirror array (40) which is uniformly illuminated and imaged on the surface (44) of the gravure form in the manner of image elements by means of tiltable micromirror elements (41), wherein the addressing of the mirror elements (41) changes synchronously with the rotation of the gravure form surface (44) in the manner of a shift register so that the allocation of an image pixel to the surface (44) of the printing form is maintained along with its corresponding exposure data value along the entire imaging surface of the mirror array (40) on the form surface (44).

20. Process according to one of the preceding claims, characterized in that image pixels which are smaller than a gravure cell are addressed on the surface of the printing form so that a gravure cell is produced from a plurality of image pixels.

21. Process according to claim 20, characterized in that the image pixels are ablated in a number of steps of different depth ranging from 2 to 256.

22. Process according to claim 20, characterized in that surfaces (image pixels) which are smaller than the surface elements of the base screen of the gravure blank form (1) are addressed by the image-forming ablation (3) and this addressing is carried out independently from the base screen.

23. Process according to claim 20, characterized in that surfaces (image pixels) which are smaller than the surface elements of the base screen of the gravure blank form (1) are addressed by the image-forming ablation (3) and are arranged in a determined geometric ratio to the base screen.

24. Process according to claim 20, characterized in that structuring of the depressions of the base screen is carried out as needed according to process techniques by means of the image-forming ablation (3).

25. Apparatus for gravure for carrying out the process according to claim 1, characterized in that a device (11) for applying a liquefiable substance, an image-point transfer device (21, 30, 40) for image-forming ablation (3) on the surface of the gravure form (20), an inking system (13) and a regenerating device (15) for the base screen of the gravure blank form (1) are adjustable in the circumferential direction at a rotating gravure blank form (1) with a base screen designed for at least the maximum amount of ink to be transferred.

26. Apparatus according to claim 25, characterized in that the gravure blank form (1) is constructed as a sleeve.

27. Apparatus according to claim 25, characterized in that two formed strips (11d, 11e) are provided for the device (11) for applying a liquefiable substance, these formed strips (11d, 11e) being provided in front of and in back of the gap between the gravure blank form (1) and the device (11) as viewed in the rotating direction of the printing form cylinder (10), wherein the formed strip (11d) in back of the gap has a sharp edge and is held in a positive engagement against the cylinder (10) at a very small distance thereto (some hundredths of a millimeter) and the formed strip (11e) in front of the gap is held against the cylinder (10) at a greater distance (several hundredths to several tenths of a millimeter).

28. Gravure blank form for use in the process according to claim 1, characterized in that the base screen has webs (9) which wind in a helical manner around the cylindrical surface at a defined angle.

29. Gravure blank form for use in the process according to claim 1, characterized in that this gravure blank form is constructed in layers, wherein a thermally insulating layer is introduced at least between a support cylinder and a surface layer containing the base screen.

30. Gravure blank form for use in the process according to claim 29, characterized in that the thermally insulating layer is formed of fiberglass-reinforced carbon.

31. Gravure blank form according to one of the preceding claims 28 to 30, characterized in that the webs (9) are constructed so as to extend vertically to the surface of the gravure form as far as possible.

32. Gravure blank form for use in the process according to claim 1, characterized in that a uniform cell-shaped base screen is provided.

33. Gravure blank form for use in the process according to claim 1, characterized in that stochastically distributed depressions are provided as a base screen.

34. Apparatus according to claim 25, characterized in that an ultrasonic cleaning installation is provided as a regenerating device (15).

35. Apparatus according to claim 34, characterized in that the ultrasonic cleaning installation can be operated on at least two different levels, wherein one level with low sonic energy and/or with a liquid which only loosens the ink serves to remove the remaining ink and the other levels serve for partial or complete removal of the filling material in the depressions of the base screen.

36. Apparatus according to claim 25, characterized in that a high-pressure water jet cleaning device is provided as regenerating device (15).

37. Apparatus according to claim 36, characterized in that the high-pressure water jet cleaning device can operate on at least two different levels, wherein one level with low liquid pressure and/or liquid temperature serves to remove remaining ink, while the additional levels with correspondingly higher liquid pressure and/or liquid temperature serve for partial or complete removal of the filling material in the depressions of the base screen.

38. Apparatus according to claim 25, characterized in that a laser (21) which is provided for applying thermal energy, in particular a high-energy laser, is used as image-point transfer unit.

39. Apparatus according to claim 38, characterized in that a semiconductor laser arrangement formed of a plurality of semiconductor lasers is provided.

40. Apparatus according to claim 25, characterized in that an absorbent foil (30) which is cut in conformity to the intended image and can be ironed on the filled base screen of the gravure blank form (1) is provided as image-point transfer device.

41. Apparatus according to claim 25, characterized in that a micromirror array (40) is provided as image-point transfer device.
